(19) United States
(12) Patent Application Publication
(10) Pub. No.: US 2023/0399072 A1
(43) Pub. Date: Dec. 14, 2023

(54) SIGNALING DEVICE FOR MOTORCYCLE RIDING GROUP

(71) Applicant: Chris Hernandez, Monroe, MI (US)

(72) Inventor: Chris Hernandez, Monroe, MI (US)

(21) Appl. No.: 18/090,232

(22) Filed: Dec. 28, 2022

Related U.S. Application Data
(60) Provisional application No. 63/343,557, filed on May 19, 2022.

(51) Int. Cl. B62J 50/25; B62J 50/28

(52) U.S. Cl. CPC B62J 50/25; B62J 50/28

(57) ABSTRACT

A visual signaling device and a method for visual signaling between members of a motorcycling group. The device includes a housing that can be mounted to a handle of a motorcycle. The device includes a plurality of lights of distinct colors, wherein each color is associated with a signal. The devices in the group can be synced with each other. The lights can be turned on by respective buttons also provided in the housing.

### CROSS-REFERENCE TO RELATED APPLICATIONS

This application claims priority from a U.S. provisional patent application Ser. No. 63/343,557, filed on May 19, 2022, which is incorporated herein by reference in its entirety.

### FIELD OF INVENTION

The present invention relates to a visual signaling and communication device, and more particularly, the present invention relates to a visual signaling device for group motorcycling activities.

### BACKGROUND

Group riding on motorcycles and bicycles is becoming increasingly popular. Riders for better experiences like to ride with friends, family, and sometimes with new people. In group riding, communication between the members of the group can be challenging. Conveying the message to group members often requires frequent stops which is time-consuming, laborious, and results in delays. Group messaging is often inconvenient and requires members to frequently check their phones. In group messaging, urgent notifications may be missed, and frequent checking of phones results in safety concerns. Communication devices, such as Bluetooth headsets are available for group communication, however, such devices are inconvenient to wear and are also expensive.

Certain physical techniques are known for communication between group motorcycle rides. For example, hand signals are used to communicate with group members during the ride. Hand signals effectively allow the members to remain coordinated. However, hand signaling suffers from several drawbacks, such as members may not remember the signals, or the signals may not be visible to all members. The hand signals do not work during the night.

A need is therefore appreciated for a novel signaling and communication device for group motorcycle and bicycle riding.

### SUMMARY OF THE INVENTION

The following presents a simplified summary of one or more embodiments of the present invention in order to provide a basic understanding of such embodiments. This summary is not an extensive overview of all contemplated embodiments and is intended to neither identify key or critical elements of all embodiments nor delineate the scope of any or all embodiments. Its sole purpose is to present some concepts of one or more embodiments in a simplified form as a prelude to the more detailed description that is presented later.

The principal object of the present invention is therefore directed to a signaling device for motorcycle riding in a group.

It is another object of the present invention that the signaling device is economical to manufacture.

It is still another object of the present invention that the signaling device works during the night.

It is yet another object of the present invention that the signaling device has good visibility.

It is a further object of the present invention that the signaling device sends a quick and clear message to all riders in a group.

It is still a further object of the present invention that the signaling device can be mounted to a handlebar.

It is an additional object of the present invention that the signaling device is safe to use.

In one aspect, disclosed is a visual signaling device for group motorcycling activities, the visual signaling device comprises: a housing configured to be mounted to a handle of a motorcycle; a plurality of lights of distinct colors, the plurality of lights provided in the housing; a plurality of buttons, wherein the plurality of buttons are associated with the plurality of lights respectively; and a control unit encased within the housing, the control unit configured to: sync the visual signaling device to other visual signaling devices, turn on the plurality of lights to stay on or blink, wherein a light of the plurality of lights is configured to be turned on by operating a respective button of the plurality of buttons. The visual signaling device comprises four lights of distinct colors. Casings of the plurality of lights form the plurality of buttons. The control unit is configured to: cause the light to blink upon pressing the respective button, to stay on upon pressing the respective button a second time, and to turn off upon pressing the respective button for a third time. The control unit is configured to: turn on the respective lights on the other visual signaling devices upon operating the respective button. The visual signaling device further comprises: a handlebar mount configured to couple to the handle of the motorcycle, wherein the housing is configured to be releasably coupled to the handlebar mount using a quick-release mechanism.

In one aspect, disclosed is a method for visual signaling between members of a motorcycling group, the method comprising: providing a plurality of visual signaling devices for a plurality of motorcycles, wherein each visual signaling device comprises: a housing configured to be mounted to a handle of a motorcycle, a plurality of lights of distinct colors, the plurality of lights provided in the housing, a plurality of buttons, wherein the plurality of buttons are associated with the plurality of lights respectively, and a control unit encased within the housing, the control unit configured to: sync the visual signaling device to other visual signaling devices of the plurality of visual signaling devices, turn on the plurality of lights to stay on or blink, wherein a light of the plurality of lights is configured to be turned on by operating a respective button of the plurality of buttons.

### BRIEF DESCRIPTION OF THE DRAWINGS

The accompanying figures, which are incorporated herein, form part of the specification and illustrate embodiments of the present invention. Together with the description, the figures further explain the principles of the present invention and to enable a person skilled in the relevant arts to make and use the invention.

FIG. 1 is a perspective view of a signaling device, according to an exemplary embodiment of the present invention.

FIG. 2 is a side view of the signaling device, according to an exemplary embodiment of the present invention.

FIG. 3 is another perspective view of the signaling device, according to an exemplary embodiment of the present invention.

FIG. 4 is another side view of the signaling device, according to an exemplary embodiment of the present invention.

FIG. 5 shows the signaling device mounted to a handle, according to an exemplary embodiment of the present invention.

### DETAILED DESCRIPTION

Subject matter will now be described more fully hereinafter with reference to the accompanying drawings, which form a part hereof, and which show, by way of illustration, specific exemplary embodiments. Subject matter may, however, be embodied in a variety of different forms and, therefore, covered or claimed subject matter is intended to be construed as not being limited to any exemplary embodiments set forth herein; exemplary embodiments are provided merely to be illustrative. Likewise, a reasonably broad scope for claimed or covered subject matter is intended. Among other things, for example, the subject matter may be embodied as methods, devices, components, or systems. The following detailed description is, therefore, not intended to be taken in a limiting sense.

The word “exemplary” is used herein to mean “serving as an example, instance, or illustration.” Any embodiment described herein as “exemplary” is not necessarily to be construed as preferred or advantageous over other embodiments. Likewise, the term “embodiments of the present invention” does not require that all embodiments of the invention include the discussed feature, advantage, or mode of operation.

The terminology used herein is to describe particular embodiments only and is not intended to be limiting to embodiments of the invention. As used herein, the singular forms “a”, “an” and “the” are intended to include the plural forms as well, unless the context clearly indicates otherwise. It will be further understood that the terms “comprise”, “comprising,”, “includes” and/or “including”, when used herein, specify the presence of stated features, integers, steps, operations, elements, and/or components, but do not preclude the presence or addition of one or more other features, integers, steps, operations, elements, components, and/or groups thereof.

The following detailed description includes the best currently contemplated mode or modes of carrying out exemplary embodiments of the invention. The description is not to be taken in a limiting sense but is made merely to illustrate the general principles of the invention since the scope of the invention will be best defined by the allowed claims of any resulting patent.

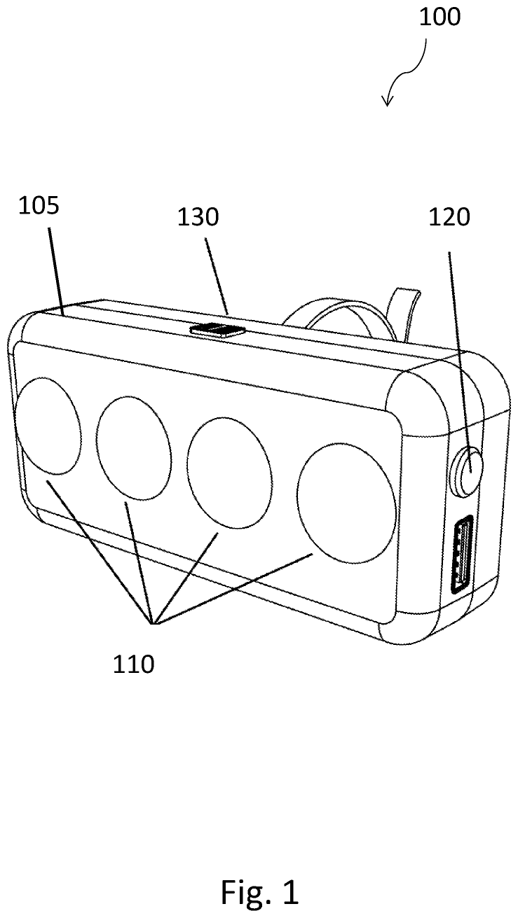

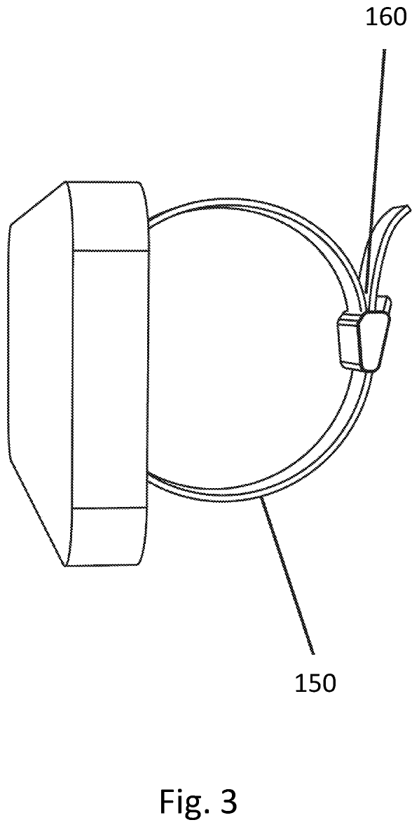

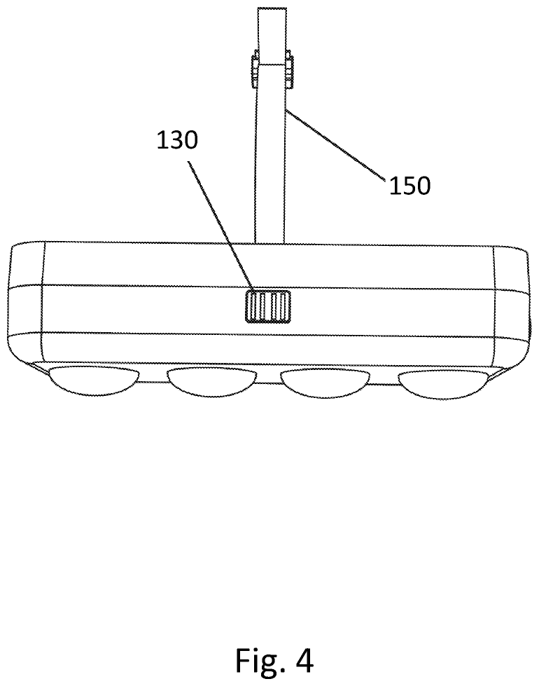

Disclosed is a signaling device for use in signaling and communication between members of a motorcycle-riding or bicycle-riding group. The disclosed signaling device can be mounted to a handlebar of each motorcycle in the group, and the signaling devices in the group can be in sync with each other. The disclosed signaling device allows the members of the group to signal each other quickly and without any confusion. Referring to FIGS. 1-4 show an exemplary embodiment of the disclosed signaling device. The signaling device 100 includes four lights of different colors, such as red, yellow, orange, and blue. The lights can be LED lights or any other light that is energy efficient. Also, it is understood that the number of lights and the color of lights can be varied without departing from the scope of the present invention. The lights may be big enough to be easily visible to the rider and other nearby riders. The signaling device includes a housing 105 that encases the electrical components of the disclosed signaling device 100. The lights can be mounted in the housing, wherein the housing can be waterproof and opaque to prevent damage to the encased components. The housing can be manufactured in diverse colors and shapes for aesthetic appearance. Moreover, the housing can be made from plastic or metal sheet. Preferably, the edges and corners of the housing can be rounded to remove sharp edges and for aesthetic appearance.

The signaling device 100 can further include a sync button 120 that can be used to sync between multiple signaling devices. For example, all the devices in the group of people can be synched with each other. When synced, a signal given by one device can be displayed on other synced devices. Thus, the signaling device 100 in sync can communicate with each other. Some pre-defined rules can be made if how the signaling devices 100 can be synced with each other. For example, the disclosed signaling devices should be within a pre-defined distance and the sync button of the signaling devices being in a pressed state for the signaling devices to sync with each other. Similarly, any other rules may be defined for syncing two or more of the signaling devices. In one implementation, the members of the group can sync their devices upon starting the journey or at some meeting point.

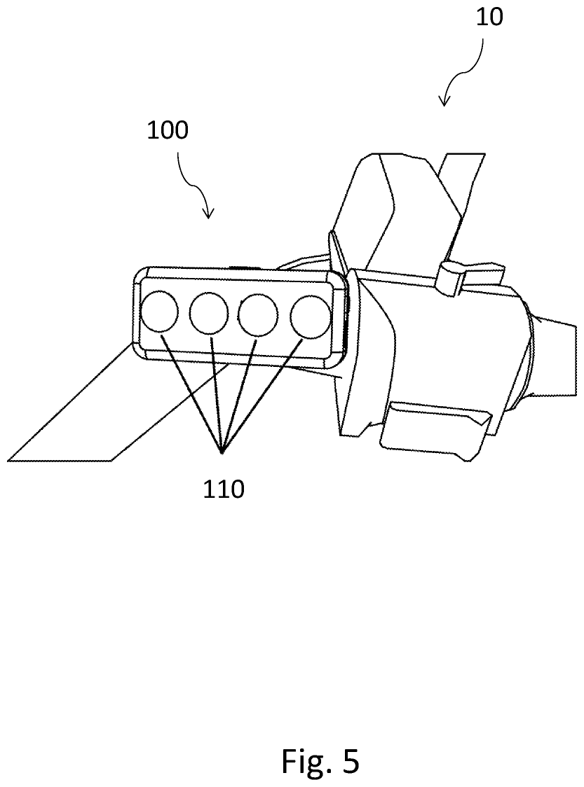

The signaling device 100 can also have a handlebar mount 150 that can be used to secure the disclosed signaling device to a tubular structure, such as a handlebar of a motorcycle or a bicycle. The handlebar mount can include a strap and a zip tie clamp 160. The strap can go around the handlebar and be tightened using the zip tie clamp. It is understood, however, that any other mechanism for mounting the disclosed signaling device to a tubular structure is within the scope of the present invention. For example, suitable clamps can also be used to mount the disclosed signaling device to the handlebar. The handlebar mount 150 can be coupled to housing 105 on its rear side. FIG. 5 shows the disclosed signaling device 100 mounted to a handlebar 10 of a motorcycle.

The handlebar mount 150 can be coupled to the housing through a quick-release mechanism, such as the housing 105 can be coupled to the handlebar mount 150 as and when desired. For example, a snap-fit type of quick-release mechanism can be provided that allows securing the housing 105 to the handlebar mount 150. A quick-release button 130 is also shown in FIG. 1, the quick-release button 130 can be operably coupled to the quick-release mechanism, such as the quick-release button 130 can be actuated to unfasten the quick-release mechanism and release the handlebar mount 150. The quick-release button 130 can be a slide button, which can be slid to release the handlebar mount 150 from the quick-release mechanism.

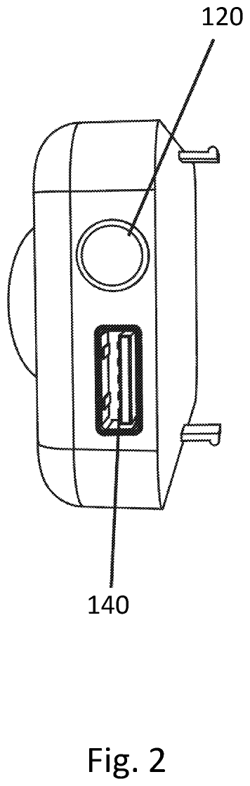

A charging port 140 is shown in FIG. 2 which allows charging an inbuilt battery of the disclosed signaling device 100. Suitable rechargeable batteries, such as lithium-ion batteries can be used and encased within the housing. A charging circuitry can also be provided for charging the encased battery. The charging port 140 can be connected to the charging circuitry. The charging port can be a standard charging port, such as having a USB interface. It is understood that the charging port, the sync button, and the quick-release button can also be sealed to prevent the ingress of dust and water.

In operation, four distinct color lights can be associated with four types of signals. For example, the RED can indicate “Emergency! Pull over immediately”, the yellow light can indicate “Pull over safely somewhere)”, the orange light can indicate “Go to the gas station”, and the BLUE light can indicate Restroom break.

Any of the four indicators can be activated by a member of the group, such as the leader of the group. The activated light can start blinking on all the signaling devices that are previously synchronized with each other. The light can be activated by pressing an associated button, such as a push button. In one case, the casing of the lights can act as the push button. Alternatively, separate push buttons can be provided adjacent to the respective lights.

In one implementation, a rider of a group of motorcycle riders wishing to communicate a message to a lead person of the group can press an appropriate button. For example, the rider may need the gas, and an orange light may be associated with this message. Upon pressing the orange button, the orange light on the signaling device starts blinking. In one case, the orange lights on all the signaling device in sync with each other starts blinking. In an alternate case, only the signaling device of the lead member blinks i.e., the orange light of the signaling device of the lead member. Still, in an alternate implementation, the orange lights of both the member wishing to signal and that of the lead member can blink. The lead member upon seeing the blinking light can acknowledge the same by pressing the button associated with the blinking light. Upon pressing the button of the blinking light, the blinking stops, and the respective light remain on. In one case, upon pressing the button by the lead member, the blinking stops in all the signaling devices that were blinking. This acknowledges that the lead member has seen the signal. The respective light can be turned off by pressing the associated button a third time. The rider initiating the signal can press the button a third time. in this case, the rider can press the button associated with the orange light to turn the orange light off.

In one implementation, a rider also referred to hereinafter as a sender, can send a message to all the members including the lead member. the sender can operate the button of the respective light associated with the message. The first actuation of the button may result in starting of blinking of the respective light in all the synced signaling devices. For example, the button associated with the orange light was pressed by the sender, and the orange light in all the synced signaling devices starts blinking. The blinking of the orange light conveys the message to the members. Each member can acknowledge the message by pressing the button of the blinking light in their signaling devices. In this case, the button is associated with orange light. Upon pressing the button, the blinking stops on the respective device, and the light remains on. Similarly, all the members may acknowledge by pressing the button associated with the blinking light on their signaling device. the sender can anytime turn off the light on all the signaling devices by again pressing the respective button.

For example, in a group of four A, B, C, and D, member D wishes to convey a message to message to other members i.e., A, B, and C. Member D can operate the light associated with the message on his signaling device by actuating the button associated with the respective light, such as the orange light. The orange light starts blinking on the signaling devices of A, B, and C. A upon seeing the blinking orange light can acknowledge the same by pressing the button associated with the orange light on his signaling device. Upon pressing the button, the blinking of light in the signaling device of A stops, and the light remains on. Similarly, B and C can also acknowledge the message on their signaling devices. In one implementation, the light after acknowledgment can automatically turn off after a predefined duration. Alternatively, the members can again press the respective button i.e., the orange light button in this case to turn off the respective light. Sill in an alternate implementation, D, the sender of the message can press the orange light button to turn off the lights in all the signaling devices of A, B, and C.

In one embodiment, the motorcycle group has members A, B, C, and D and among them, A can be the lead member. The signaling devices in motorcycles of A, B, C, and D can be in sync. D wishing to send a message to the group can turn on the light associated with the message, taking, for example, redlight light by pressing the red button to convey the message to the lead member “A”. Upon pressing the red button by D, the red light in the signaling device of A can start blinking. A acknowledges the message by pressing the red button on his signaling device which stops the blinking red light to stop blinking and remains on. Now D can press the red button again on his device which turns the off the red light on the signaling device of A. It is understood that red light and orange light are taken as examples, and the colors in the signaling light may vary without departing from the scope of the present invention. Also, the members can press the desired button to convey their messages and are not limited to red or orange.

In one embodiment, the motorcycle group has members A, B, C, and D and among them, A can be the lead member. The signaling devices in motorcycles of A, B, C, and D can be in sync. D wishing to send a message to the group can turn on the light associated with the message, taking, for example, redlight light by pressing the red button to convey the message to the lead member “A”. Upon pressing the red button by D, the red light in the signaling device of A can start blinking. A upon seeing the blinking red light can acknowledge the message by pressing the red button on his signaling device which stops the red light from blinking and the red light remains on. Now D can press the red button again on his device which turns the off the red light on the signaling device of A. It is understood that red light and orange light are taken as examples, and the colors in the signaling light may vary without departing from the scope of the present invention. Also, the members can press the desired button to convey their messages and are not limited to red or orange.

In one embodiment, the motorcycle group has members A, B, C, and D and among them, A can be the lead member. The signaling devices in motorcycles of A, B, C, and D can be in sync. D wishing to send a message to the group can turn on the light associated with the message, taking, for example, redlight light by pressing the red button to convey the message to the lead member “A”. Upon pressing the red button by D, the red light in the signaling devices of A and D can start blinking. A upon seeing the blinking red light on his signaling device can acknowledge the message by pressing the red button on his signaling device which stops the red light from blinking and the red light on both the signaling devices of A and D remains on. Now D can press the red button again on his signaling device which turns the off the red light on the signaling devices of A and D. It is understood that red light and orange light are taken as examples, and the colors in the signaling light may vary without departing from the scope of the present invention. Also, the members can press the desired button to convey their messages and are not limited to red or orange.

In one embodiment, the motorcycle group has members A, B, C, and D and among them, A can be the lead member. The signaling devices in motorcycles of A, B, C, and D can be in sync. D wishing to send a message to the group can turn on the light associated with the message, taking, for example, red light by pressing the red button to convey the message to the lead member “A”. Upon pressing the red button by D, the red light in the signaling devices of A, B, and C can start blinking. A upon seeing the blinking red light can acknowledge the message by pressing the red button on his signaling device which stops the red light from blinking on all the signaling devices and the red light remains on. Now D can press the red button again on his signaling device which turns the off the red light on all the signaling devices. It is understood that red light and orange light are taken as examples, and the colors in the signaling light may vary without departing from the scope of the present invention. Also, the members can press the desired button to convey their messages and are not limited to red or orange.

In one embodiment, the motorcycle group has members A, B, C, and D and among them, A can be the lead member. The signaling devices in motorcycles of A, B, C, and D can be in sync. D wishing to send a message to the group can turn on the light associated with the message, taking, for example, red light by pressing the red button to convey the message to the lead member “A”. Upon pressing the red button by D, the red light in the signaling devices of A, B, C, and D can start blinking. A upon seeing the blinking red light can acknowledge the message by pressing the red button on his signaling device which stops the red light from blinking on all the signaling devices of A, B, C, and D and the red light remains on. Now D can press the red button again on his signaling device which turns the off the red light on all the signaling devices. It is understood that red light and orange light are taken as examples, and the colors in the signaling light may vary without departing from the scope of the present invention. Also, the members can press the desired button to convey their messages and are not limited to red or orange.

In one implementation, the lights can have associated buttons adjacent to the respective lights. The buttons may be color codes or can be plain. either the button or the respective light must be color coded. Or the colored light casing of the light can act as the button for the light which can be pressed. Still, in an alternate implementation, a single light that can generate different colors can be provided and color-coded buttons can be used to select the color of the light.

While the foregoing written description of the invention enables one of ordinary skill to make and use what is considered presently to be the best mode thereof, those of ordinary skill will understand and appreciate the existence of variations, combinations, and equivalents of the specific embodiment, method, and examples herein. The invention should therefore not be limited by the above-described embodiment, method, and examples, but by all embodiments and methods within the scope and spirit of the invention as claimed.

What is claimed is:

1. A visual signaling device for group motorcycling activities, the visual signaling device comprises:
a housing configured to be mounted to a handle of a motorcycle;
a plurality of lights of distinct colors, the plurality of lights provided in the housing;
a plurality of buttons, wherein the plurality of buttons are associated with the plurality of lights respectively; and
a control unit encased within the housing, the control unit configured to:
sync the visual signaling device to other visual signaling devices,
turn on the plurality of lights to stay on or blink, wherein a light of the plurality of lights is configured to be turned on by operating a respective button of the plurality of buttons.

2. The visual signaling device according to claim 1, wherein the visual signaling device comprises four lights of distinct colors.

3. The visual signaling device according to claim 1, wherein casings of the plurality of lights form the plurality of buttons.

4. The visual signaling device according to claim 1, wherein the control unit is configured to:
cause the light to blink upon pressing the respective button,
to stay on upon pressing the respective button a second time, and
to turn off upon pressing the respective button for a third time.

5. The visual signaling device according to claim 1, wherein the control unit is configured to:
turn on the respective lights on the other visual signaling devices upon operating the respective button.

6. The visual signaling device according to claim 1, wherein the visual signaling device further comprises:
a handlebar mount configured to couple to the handle of the motorcycle, wherein the housing is configured to be releasably coupled to the handlebar mount using a quick-release mechanism.

7. A method for visual signaling between members of a motorcycling group, the method comprising:
providing a plurality of visual signaling devices for a plurality of motorcycles, wherein each visual signaling device comprises:
a housing configured to be mounted to a handle of a motorcycle,
a plurality of lights of distinct colors, the plurality of lights provided in the housing,
a plurality of buttons, wherein the plurality of buttons are associated with the plurality of lights respectively, and
a control unit encased within the housing, the control unit configured to:
sync the visual signaling device to other visual signaling devices of the plurality of visual signaling devices,
turn on the plurality of lights to stay on or blink, wherein a light of the plurality of lights is configured to be turned on by operating a respective button of the plurality of buttons.

8. The method according to claim 7, wherein the visual signaling device comprises four lights of distinct colors.

9. The method according to claim 7, wherein casings of the plurality of lights form the plurality of buttons.

10. The method according to claim 7, wherein the control unit is configured to:
cause the light to blink upon pressing the respective button,
to stay on upon pressing the respective button a second time, and
to turn off upon pressing the respective button for a third time.

11. The method according to claim 7, wherein the control unit is configured to:
turn on the respective lights on the other visual signaling devices upon operating the respective button.

12. The method according to claim 7, wherein the visual signaling device further comprises:
a handlebar mount configured to couple to the handle of the motorcycle, wherein the housing is configured to be releasably coupled to the handlebar mount using a quick-release mechanism.
